(19) United States
(12) Patent Application Publication
(10) Pub. No.: US 2013/0111344 A1
(43) Pub. Date: May 2, 2013

(54) HELP CREATION SUPPORT APPARATUS, HELP CREATION METHOD, AND STORAGE MEDIUM STORING HELP CREATION PROGRAM

(71) Applicants: Mitsuru SATO, Kawasaki (JP); Yoshitomo Kumagai, Yokohama (JP); Tomomitsu Murano, Fuchu (JP)

(72) Inventors: Mitsuru SATO, Kawasaki (JP); Yoshitomo Kumagai, Yokohama (JP); Tomomitsu Murano, Fuchu (JP)

(73) Assignee: FUJITSU LIMITED, Kawasaki-shi (JP)

(21) Appl. No.: 13/592,651

(22) Filed: Aug. 23, 2012

(30) Foreign Application Priority Data
Oct. 31, 2011 (JP) 2011-239671

(51) Int. Cl. G06F 3/01

(52) U.S. Cl. 715/708

(57) ABSTRACT

A help creation support apparatus includes: an identification unit to identify a operational component included in a graphical interface based on source code of the graphical interface; a generation unit to generate management information including identification information that represents the identified operational component; a storage unit to store the management information; an input unit to input a help corresponding to the operational component to be added to the management information stored in the storage unit for identification information; and a file creation unit to create a file in which the help corresponding to the operational component is stored based on management information to which the help is added.

### CROSS-REFERENCE TO RELATED APPLICATION(S)

This application is based upon and claims the benefit of priority of the prior Japanese Patent Application No. 2011-239671, filed on Oct. 31, 2011, the entire contents of which are incorporated herein by reference.

### FIELD

The embodiment discussed herein relates to a help creation support apparatus, help creation method, and storage medium storing help creation program.

### BACKGROUND

Software includes help, which is a description of an operation procedure and the like. Context-sensitive help includes pop-up descriptions about operational components of a graphical interface such as buttons, check buttons, radio buttons, and edit boxes.

Related-art examples are disclosed in Japanese Laid-open Patent Publication No. 9-54688, Japanese Laid-open Patent Publication No. 2010-186378, and Japanese Laid-open Patent Publication No. 2000-222192.

### SUMMARY

According to one aspect of the embodiments, a help creation support apparatus includes: an identification unit to identify a operational component included in a graphical interface based on source code of the graphical interface; a generation unit to generate management information including identification information that represents the identified operational component; a storage unit to store the management information; an input unit to input a help corresponding to the operational component to be added to the management information stored in the storage unit for identification information; and a file creation unit to create a file in which the help corresponding to the operational component is stored based on management information to which the help is added.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary help creation support apparatus;

FIG. 2 illustrates an exemplary source code folder;

FIG. 3 illustrates an exemplary graphical interface;

FIG. 4 illustrates an exemplary component ID;

FIG. 5 illustrates an exemplary header file;

FIG. 6 illustrates an exemplary management table;

FIG. 7 illustrates an exemplary data of a help text file;

FIG. 8 illustrates an exemplary source code;

FIG. 9 illustrates an exemplary process of a control unit;

FIG. 10 illustrates an exemplary management table;

FIG. 11 illustrates an exemplary display of context-sensitive help;

FIG. 12 illustrates an exemplary modification to an operational component;

FIG. 13 illustrates an exemplary component ID;

FIG. 14 illustrates an exemplary management table;

FIG. 15 illustrates an exemplary notification;

FIG. 16 illustrates an exemplary management information generation process;

FIG. 17 illustrates an exemplary file creation process; and

FIG. 18 illustrates an exemplary computer.

### DESCRIPTION OF EMBODIMENT

Examples of program creation support include automatic creation of source code for an entire graphical interface by reading the functions of the components of the graphical interface created using a design support tool from a library that stores the functions. For example, when a change is made to the software of a user interface (UI) element, a UI component for describing details of the change may be mechanically embedded in the vicinity of the UI element. For example, a specification may be created by reflecting the difference between a previous specification created based on the original source and a current specification created based on modified original source to the specification.

A modification to the basis of a program, source code, and creation of the basis of a help, a text file, may be performed separately. A help may be updated in accordance with a software update. For this reason, a mismatch between an operational component and a corresponding help may occur owing to a failure to update the help, such as a failure to add a description thereto or a failure to delete a description therefrom.

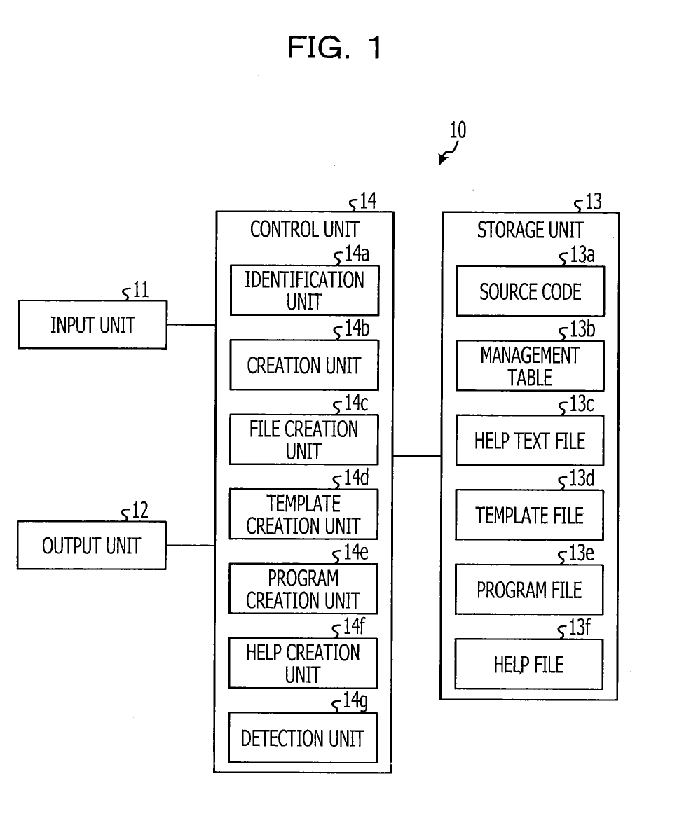

FIG. 1 illustrates an exemplary help creation support apparatus. A help creation support apparatus 10 may be a computer that supports the creation of help for operational components of a graphical interface. The help creation support apparatus 10 may be, for example, a computer with which a developer develops software. Alternatively, the help creation support apparatus 10 may be a management server that manages the source code of software developed by each developer. Herein, the help creation support apparatus 10 corresponding to a computer with which a developer develops software includes an input unit 11, an output unit 12, a storage unit 13, and a control unit 14.

The input unit 11 inputs various types of information to the control unit 14. For example, the input unit 11 receives operations performed by the developer and inputs operation information indicating details of the received operations to the control unit 14. The input unit 11 may include an operation receiving device such as a mouse or keyboard.

The output unit 12 outputs various types of information. For example, the output unit 12 displays a message indicating an operational component whose change has been detected by a detection unit 14g. Devices corresponding to the output unit 12 may include a display device such as a liquid crystal display (LCD) or cathode ray tube (CRT).

The storage unit 13 stores various types of information. For example, the storage unit 13 stores source code 13a, a management table 13b, a help text file 13c, a template file 13d, a program file 13e, and a help file 13f. Devices corresponding to the storage unit 13 may include a storage device such as a data-rewritable semiconductor memory, a hard disk, or an optical disk. Examples of a data-rewritable semiconductor memory include a flash memory and non-volatile static random access memory (nvSRAM).

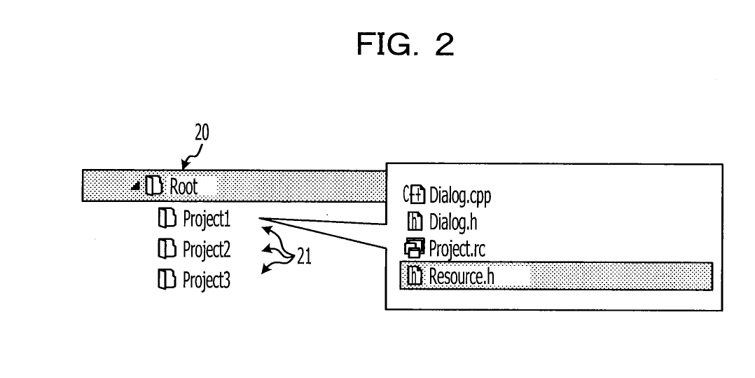

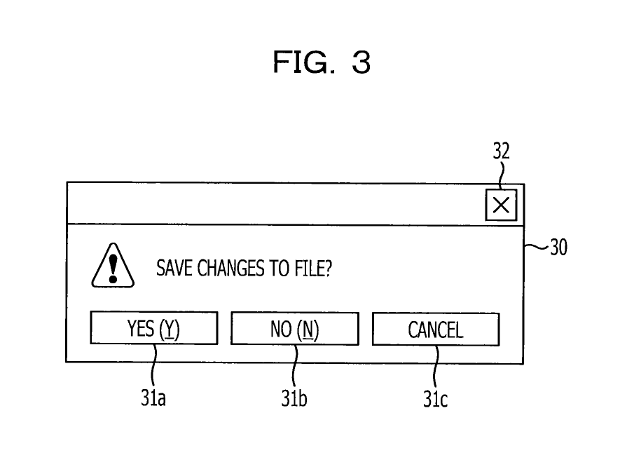

The source code 13a may be in a programming language for processes related to the graphical interface program written by the developer. For example, the developer may write processes to be performed by operational components of the graphical interface, in a programming language in which the graphical interface is created, such as Visual C++. The source code 13a may include code related to the operational components of the graphical interface or code representing details of the processes performed by the operational components. FIG. 2 illustrates an exemplary source code folder. Source code illustrated in FIG. 2 may be in Visual C++. In FIG. 2, a folder Root 20 contains three projects 21, “Project 1” to “Project 3.” The projects 21 manage files for creating an execution file such as EXE or DLL. “Project 1” illustrated in FIG. 2 manages files for generating a graphical interface program, for example, files “Dialog.cpp”, “Dialog.h”, “Project.rc”, and “Resource.h”. FIG. 3 illustrates an exemplary graphical interface. A graphical interface illustrated in FIG. 3 may be generated in the form of a graphical interface program. In FIG. 3, three buttons, 31a to 31c, indicating “YES (Y)”, “NO (N)”, and “Cancel”, respectively, are disposed as operational components of a graphical interface 30. A close button 32 is disposed in the upper-right portion of the graphical interface 30. The close button 32 is used to request that the graphical interface 30 be closed and not displayed. Component IDs (identifiers) are set to the buttons 31a to 31c. For example, a component ID “ID_OK” is set to the button 31a, a component ID “ID_NO” is set to the button 31b, and a component ID “ID_CANCEL” is set to the button 31c. Values may be set to the component IDs.

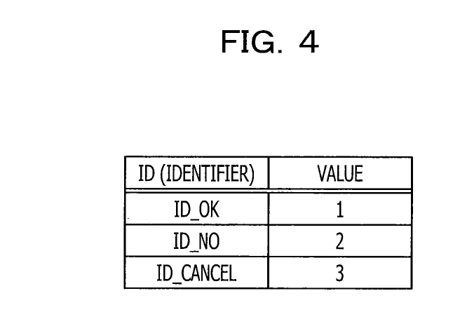

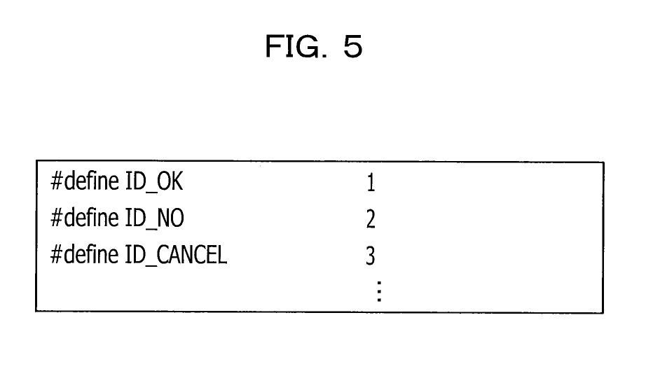

FIG. 4 illustrates an exemplary component. FIG. 4 illustrates the component IDs of the buttons. In FIG. 4, “1” is set to the component ID “ID_OK” of the button 31a; “2” to the component ID “ID_NO” of the button 31b; and “3” to the component ID “ID_CANCEL” of the button 31c. In Visual C++, definitions are made using a header file so that values are set to the component IDs of the operational components of the graphical interface. FIG. 5 illustrates an exemplary header file. The header file illustrated in FIG. 5 may be the header file of the graphical interface program illustrated in FIG. 3. In FIG. 5, #define statements are used to set “1” to “ID_OK”, “2” to “ID_NO”, and “3” to “ID_CANCEL2.

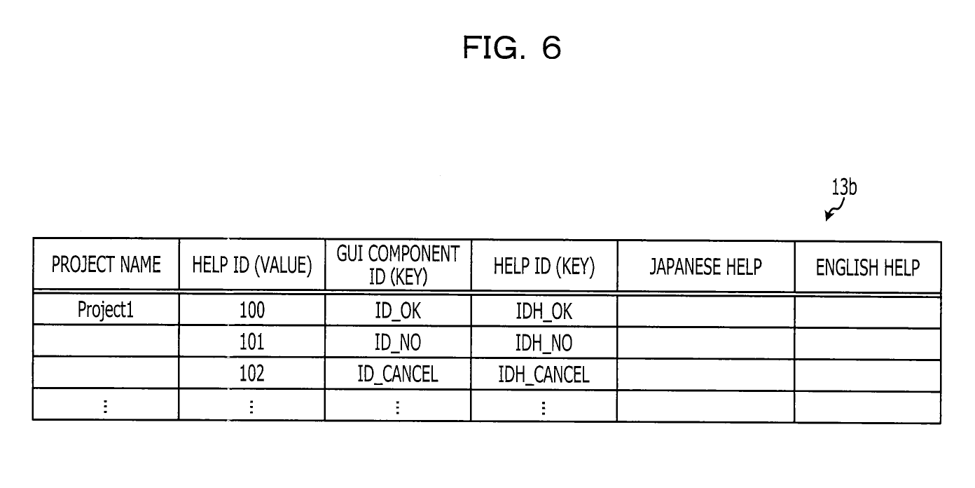

The management table 13b may be a table for storing information about the operational components of the graphical interface. FIG. 6 illustrates an exemplary management table. As illustrated in FIG. 6, the management table 13b includes the fields “project name”, “help ID (value)”, “graphical user interface (GUI) component ID (key)”, “help ID (key)”, “Japanese help”, and “English help”. The field “project name” may be an area for storing a project name of a graphical interface program. The field “help ID (value)” may be an area for storing the value of a help ID that a graphical interface program uses to call a help message. Help IDs may be automatically numbered so that the values thereof do not overlap each other. The field “GUI component ID (key)” may be an area for storing the component IDs of operational components. The field “help ID (key)” may be an area for storing help IDs. The field “Japanese help” may be an area for storing Japanese help messages. The field “English help” may be an area for storing English help messages. Various types of information related to the graphical interface program illustrated in FIG. 3 may be stored in the management table 13b. “Project 1” includes the three operational components having the component IDs “ID_OK”, “ID_NO, and “ID_CANCEL”, respectively. The operational component having the component ID “ID_OK” has a help ID value “100” and a help ID “IDH_OK”. The operational component having the component ID “ID_NO” has a help ID “101” and a help ID “IDH_NO”. The operational component having the component ID “ID_CANCEL” has a help ID “102” and a help ID “IDH_CANCEL”.

The management table 13b may be created by a creation unit 14b. The fields “Japanese help” and “English help” of the management table 13b may be areas into which the developer puts entries and may initially have no entries when the management table 13b is created. The management table 13b may be used in a process performed by a file creation unit 14c.

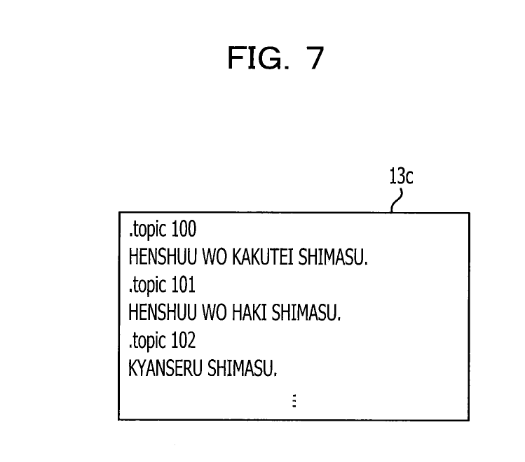

The help text file 13c is a file where help messages for operational components are listed. FIG. 7 illustrates exemplary data of a help text file. As illustrated in the help text file 13c of FIG. 7, a help ID value is written after each “topic”, and a help message is written for each help ID. In FIG. 7, a help message reading “Henshuu wo kakutei shimasu (Changes to the file will be saved)” is written for a help ID “100”. A help message reading “Henshuu wo haki shimasu (Changes to the file will not be saved)” is written for a help ID “101”. A help message reading “Kyanseru shimasu (This graphical interface will be closed)” is written for a help ID “102”.

The help text file 13c may be created by the file creation unit 14c. The help text file 13c may be used in a process performed by a help creation unit 14f.

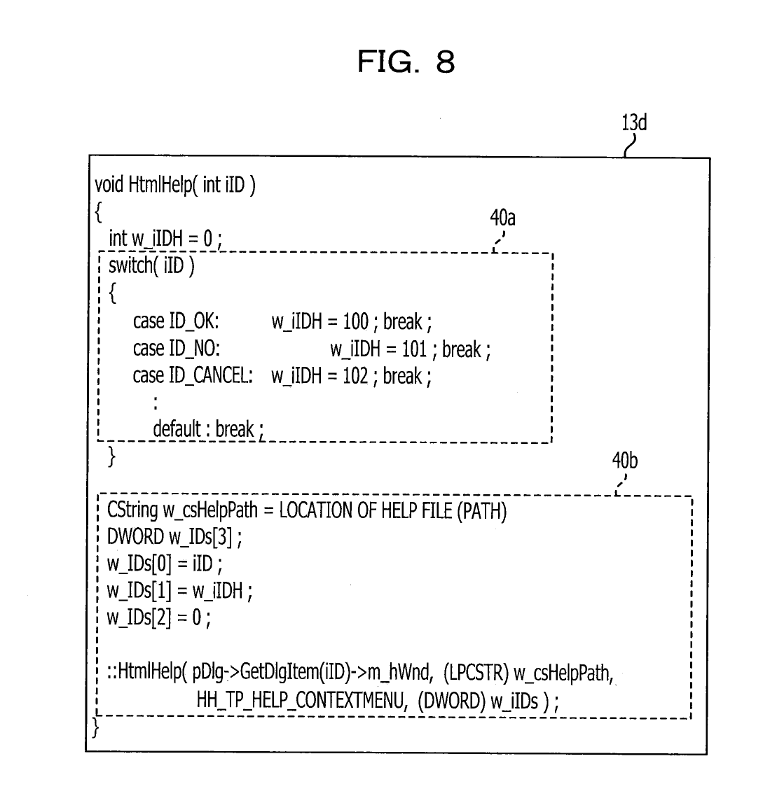

The template file 13d may be a source code file in which a process for displaying help messages that correspond to the operational components of the graphical interface is written. FIG. 8 illustrates an exemplary source code. The source code illustrated in FIG. 8 may be Visual C++ source code in which a process for displaying help is written. As illustrated in FIG. 8, the template file 13d includes a code portion 40a in which a process for associating an operational component with a help ID is written and a code portion 40b in which a process for calling a help message is written. A process that varies for each the operational component of the graphical interface may be written in the code portion 40a. For example, a help display that corresponds to a process of determining the component ID of a designated operational component using a SELECT statement and setting a value of a help ID, which corresponds to the designated operational component, to a variable w_iIDH is written in the code portion 40a. In the code portion 40a illustrated in FIG. 8, when the value of a variable iID is the value of ID_OK, the variable w_iIDH is set to “100”, the value of a help ID that corresponds to ID_OK. In the code portion 40a, when the value of the variable iID is the value ID_NO, the variable w_iIDH is set to “101”, the value of a help ID that corresponds to ID_NO. In the code portion 40a, when the value of the variable iID is a value ID_CANCEL, “102”, the value of a help ID that corresponds to ID_CANCEL is set to the variable w_iIDH.

A routine process which does not change according with the operational components of the graphical interface is written in the code portion 40b. In FIG. 8, a process of setting an argument and calling an HtmlHelp function for calling help is written in the code portion 40b.

The template file 13d illustrated in FIG. 1 may be created by a template creation unit 14d. The template file 13d may be used in a process performed by a program generation unit 14e.

The program file 13e is created by converting the source code 13a into computer-executable form. The program generation unit 14e may create the management table 13b by converting the source code 13a into an executable file such as by building.

The help file 13f may be a file obtained by converting the help text file 13c into a form that can be read from the program file 13e. Alternatively, the help creation unit 14f may create the help file 13f by converting the help text file 13c into, for example, the Microsoft compiled HTML help (CHM) format.

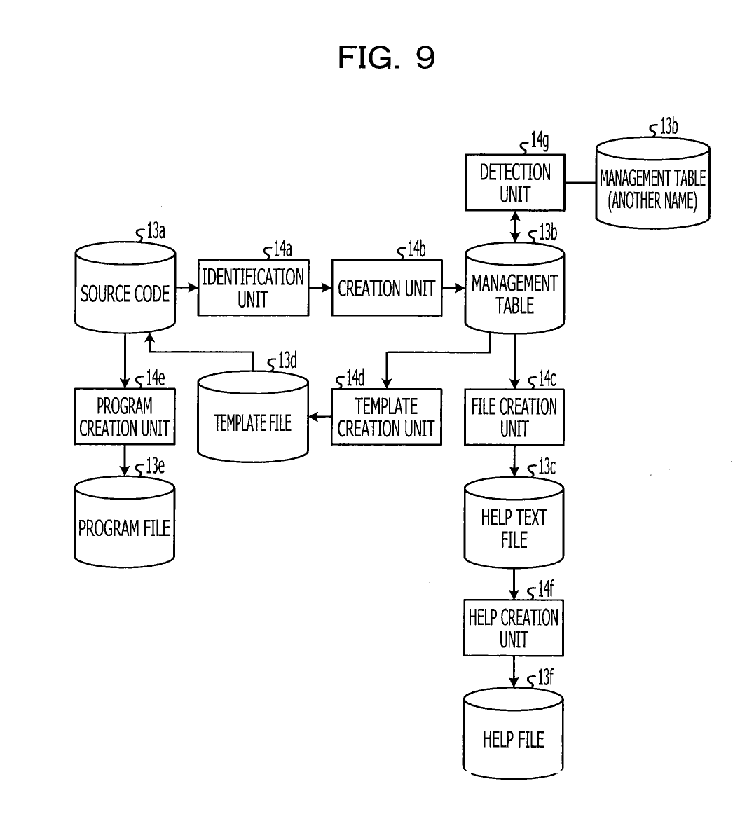

The control unit 14 performs control for creating a help message. Devices corresponding to the control unit 14 may include an electronic circuit such as a central processing unit (CPU) or micro processing unit (MPU). As illustrated in FIG. 1, the control unit 14 includes an identification unit 14a, the generation unit 14b, the file creation unit 14c, the template creation unit 14d, the program creation unit 14e, the help creation unit 14f, and the detection unit 14g. FIG. 9 illustrates an exemplary processing of a control unit. In FIG. 9, the flow of the processing performed by the control unit is illustrated schematically.

The identification unit 14a performs various types of identification. For example, the identification unit 14a identifies an operational component included in the graphical interface based on the source code 13a of the graphical interface.

For example, the source code 13a of the graphical interface may have the folder configuration of “Project 1” illustrated in FIG. 2. The identification unit 14a refers to a header file Resource.h to identify an operational component included in the graphical interface. For example, when the header file is a header file illustrated in FIG. 5, the identification unit 14a identifies that three operational components having identifiers “ID_OK”, “ID_NO”, and “ID_CANCEL,” respectively, are included in the graphical interface.

The creation unit 14b performs various types of creation. For example, the creation unit 14b creates the management table 13b as information for managing the operational components identified by the identification unit 14a. The creation unit 14b numbers the help IDs of the identified operational components in such a manner that the values of the help IDs do not overlap each other, for example, in ascending order. The creation unit 14b creates the help IDs of the operational components under a given rule so that the help IDs do not overlap the component IDs thereof. For example, the creation unit 14b creates a help ID that corresponds to an operational component by converting “ID_”, which is included in the component ID of the operational component, into “IDH_”. The creation unit 14b creates a management table 13b where a component ID, a created help ID, and a numbered help ID value are set for each operational component of each project. In the created management table 13b, as illustrated in FIG. 6, a help ID value, a component ID, and a help ID are set for each operational component of the graphical interface, while respective Japanese and English help messages are provided with no entries. The created management table 13b is stored in the storage unit 13.

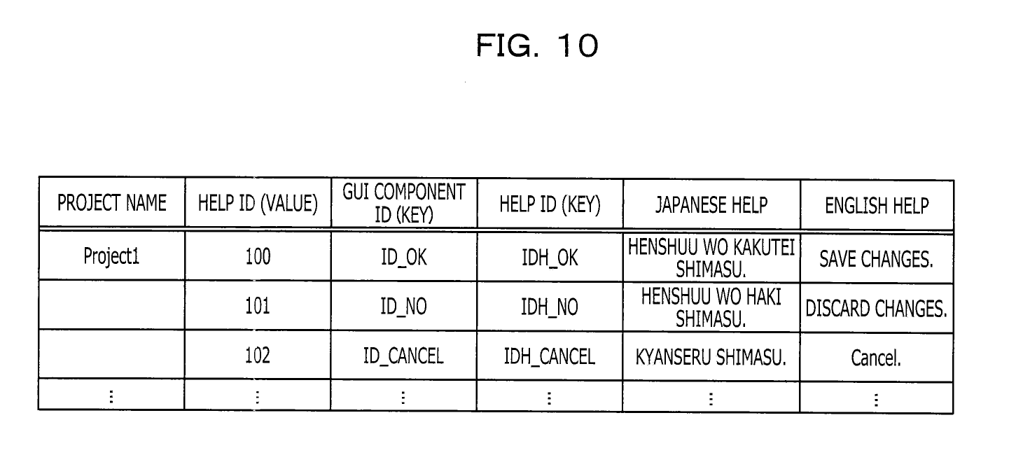

Details of Japanese and English help messages to be set in the management table 13b are input via the input unit 11. The input unit 11 receives input of the Japanese and English help messages to be set in the management table 13b. The developer inputs, to the input unit 11, operation descriptions to be set in the Japanese and English help fields of the management table 13b for each operational component. The operation descriptions input via the input unit 11 are stored in the Japanese and English help fields of the management table 13b. FIG. 10 illustrates an exemplary management table. A management table illustrated in FIG. 10 contains Japanese and English help messages.

The file creation unit 14c performs various types of creation. For example, the file creation unit 14c creates a help text file 13c where help messages that correspond to the help IDs of operational components are listed, based on the management table 13b. For example, the designation between Japanese and English of the language in which help messages will be created is input via the input unit 11. The file creation unit 14c creates a help text file 13c where help messages in the designated language are listed. For example, if Japanese is designated as a language in which help messages are created, the file creation unit 14c creates a help text file 13c where help messages corresponding to help IDs are written in Japanese, as illustrated in FIG. 7.

When the display of a help message corresponding to an operational component of the graphical interface is requested, a process of displaying the help message on the operational component is written in the source code 13a of the graphical interface program by a developer.

The template creation unit 14d creates a source code template file 13d in which the process of displaying the help message for a operational component is written. For example, the file creation unit 14c reads a component ID value and a corresponding help ID value from the management table 13b. The file creation unit 14c creates a template file 13d including a code portion 40a and a code portion 40b. As illustrated in FIG. 8, a process of setting the value of a help ID corresponding to an operational component that has been requested to display a help message to a variable w_iIDH is written to the code portion 40a. A routine process is written in the code portion 40b.

The developer may easily write a help message reading process in the source code 13a by using the template file 13d. Records that correspond to all operational components of the graphical interface may be generated in the management table 13b based on the source code 13a. As a result, a process of calling the help messages of all the operational components of the graphical interface written in the source code 13a may be written in the template file 13d. If the developer writes a help message reading process in the source code 13a using the template file 13d, the frequency with which a process of calling a help message that corresponds to an operational component is omitted or the frequency with which an operational component and a help message are mismatched may be reduced.

The program creation unit 14e converts the source code 13a into an executable program file 13e such as by building. The program creation unit 14e may include development software, a build tool, or the like.

The help creation unit 14f converts the help text file 13c into the help file 13f. The help creation unit 14f may include a help creation tool or the like.

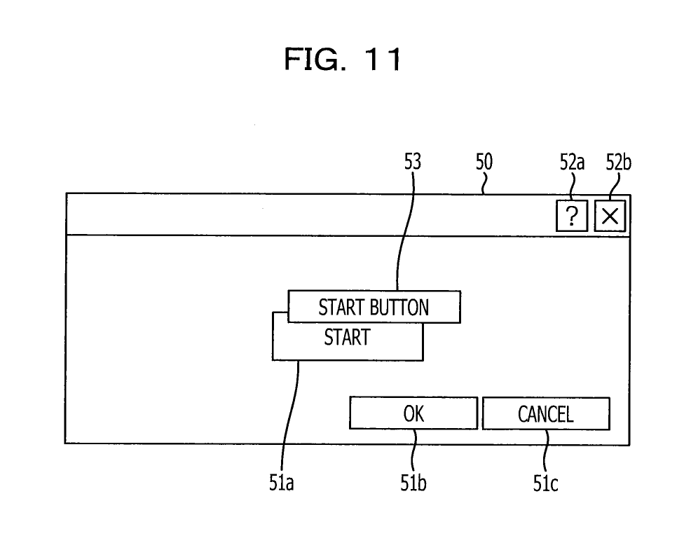

Since the created program file 13e and help file 13f are stored in the same folder, a context-sensitive help message that corresponds to an operational component is displayed on the graphical interface during execution of the program file 13e. FIG. 11 illustrates an exemplary display of a context-sensitive help message. In FIG. 11, a start button 51a, an OK button 51b, and a cancel button 51c are disposed as operational components of a graphical interface 50. In FIG. 11, a help button 52a and a close button 52b are disposed in the upper-right portion of the graphical interface 50. The help button 52a may be a button for requesting the display of a help message. The close button 52b may be a button for requesting the closure of the graphical interface 50. When displaying a help message related to the start button 51a, the OK button 51b, or the cancel button 51c, the user first selects the help button 52a and then focuses the cursor on an operational component whose help is to be displayed. For example, in FIG. 11, the developer displays a help message 53 of the start button 51a by first selecting the help button 52a and then focusing the cursor on the start button 51a.

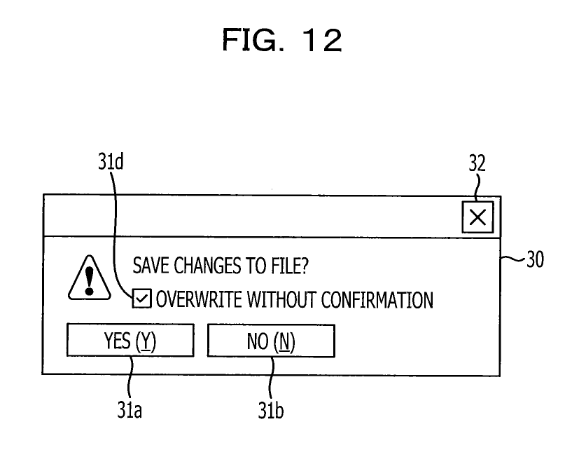

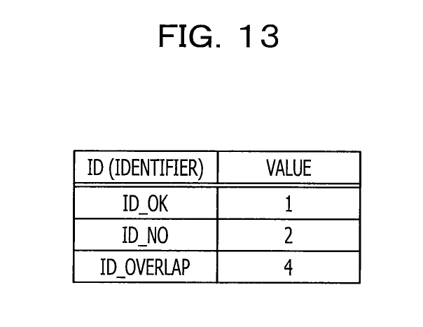

An operational component of the graphical interface may be added or detected based on a modification to the source code 13a made by the developer. For example, the developer may make a modification as illustrated in FIG. 12 to the graphical interface program illustrated in FIG. 3. FIG. 12 illustrates an exemplary modification to an operational component. In FIG. 12, the “Cancel” button 31c is deleted from the graphical interface 30 illustrated in FIG. 3, and a check box 31d for making a selection as to whether overwriting without confirmation is allowed is added thereto. The component ID of the check box 31d may be “ID_OVERLAP”. FIG. 13 illustrates an exemplary component ID. The component IDs of buttons and a check box are set. In FIG. 13, the setting of the button 31c is deleted from FIG. 3, and “4” is set to the component ID “ID_OVERLAP”.

When the source code 13a is updated, the detection unit 14g detects a changed operational component. For example, when the source code 13a is updated after the management table 13b created by the creation unit 14b is stored in the storage unit 13, the detection unit 14g changes the name of the management table 13b stored in the storage unit 13. When the creation unit 14b newly creates a management table 13b, the detection unit 14g compares the component IDs in the management table 13b having the changed name with the component IDs in the management table 13b which has been newly created by the creation unit 14b. For example, the detection unit 14g compares the component IDs in the management table 13b created from the not-updated source code 13a with the component IDs in the management table 13b created from the updated source code 13a. Based on the result of the comparison, the detection unit 14g detects an added or deleted operational component.

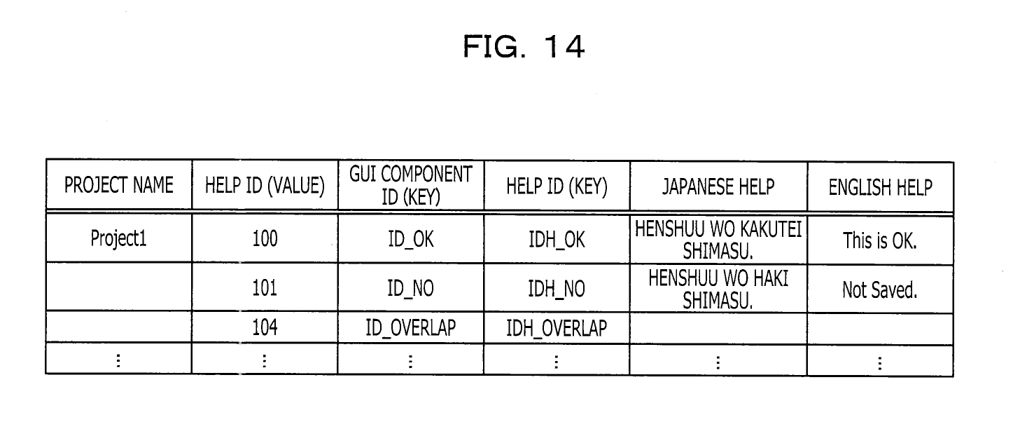

For example, the developer may make a modification illustrated in FIG. 12 to the graphical interface program illustrated in FIG. 3. FIG. 14 illustrates an exemplary management table. A management table illustrated in FIG. 14 may be a management table for the operational components of the graphical interface program illustrated in FIG. 12. In FIG. 14, a record “ID_CANCEL” is deleted from the management table 13b illustrated in FIG. 6, and a record “ID_OVERLAP” is added thereto. The detection unit 14g compares the component IDs in the management table 13b illustrated in FIG. 6 with the component IDs in the management table 13b illustrated in FIG. 14. Thus, the detection unit 14g detects that an operational component having “ID_CANCEL” has been deleted and that an operational component having “ID_OVERLAP” has been added.

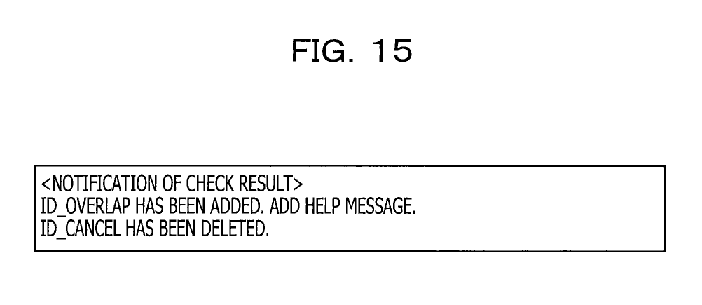

The detection unit 14g notifies the developer of the detected operational components via the output unit 12. For example, the detection unit 14g notifies the developer of the added or deleted operational components by causing the output unit 12 to display a message indicating the added or deleted operational components. FIG. 15 illustrates an exemplary notification. A notification illustrated in FIG. 15 may be a notification about the added or deleted operational components. In FIG. 15, since the operational component “ID_OVERLAP” has been added, a notification that “ID_OVERLAP has been added. Add a help message” is provided to the developer. Furthermore, since the operational component “ID_CANCEL” has been deleted, a notification that “ID_CANCEL has been deleted” is provided to the developer.

When the name of the management table 13b is changed, the detection unit 14g incorporates descriptions, which are stored in the Japanese and English help fields of the management table 13b whose name has been changed, into a newly created management table 13b for each operational component ID.

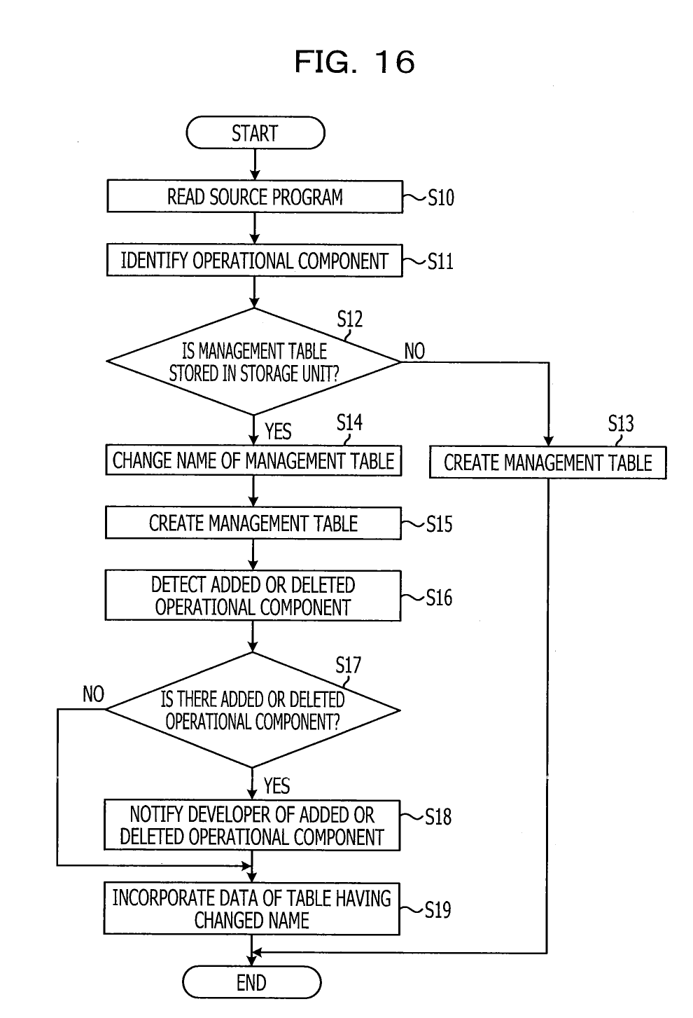

FIG. 16 illustrates an exemplary management information generation process. The generation process may be performed, for example, when an operation for requesting the help creation support apparatus 10 to generate management information is performed. Alternatively, the generation process may be performed by source code management software when the source code 13a is stored in the source code management software or when a change to the source code 13a is detected by the source code management software.

As illustrated in FIG. 16, the identification unit 14a reads the source code 13a of the graphical interface from the storage unit 13 (operation S10). The identification unit 14a identifies an operational component included in the graphical interface from the read graphical interface source code 13a (operation S11). The detection unit 14g determines whether a management table 13b is already stored in the storage unit 13 (operation S12). If no management table 13b is stored in the storage unit 13 (NO in operation S12), the creation unit 14b creates a management table 13b to manage an operational component identified by the identification unit 14a (operation S13), and the process finishes.

If a management table 13b is already stored in the storage unit 13 (YES in operation S12), the detection unit 14g changes the name of the management table 13b already stored in the storage unit 13 (operation S14). The creation unit 14b creates a management table 13b for managing an operational component identified by the identification unit 14a (operation S15). The detection unit 14g compares the component IDs in the management table 13b whose name has been changed with those in the management table 13b created by the creation unit 14b. Thus, the detection unit 14g detects added or deleted operational components (operation S16). As the result of the detection, the detection unit 14g determines whether there are added or deleted operational components (operation S17). If there are added or deleted operational components (YES in operation S17), the detection unit 14g notifies the developer of the added or deleted operational components via the output unit 12 (operation S18). The detection unit 14g, for each component ID, incorporates descriptions stored in the Japanese and English help fields of the management table 13b whose name has been changed into the newly created management table 13b (operation S19), and the process finishes. If there are no added or deleted operational components (NO in operation S17), the process proceeds to operation S19.

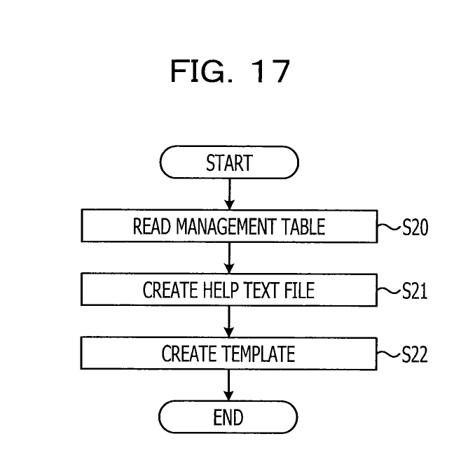

FIG. 17 illustrates an exemplary file creation process. In FIG. 17, a help text file or template file may be created. The creation process illustrated in FIG. 17 may be performed, for example, when an operation that requests the help creation support apparatus 10 to create a help text file 13c and a template file 13d is performed.

As illustrated in FIG. 17, the file creation unit 14c reads the management table 13b from the storage unit 13 (operation S20). The file creation unit 14c creates a help text file 13c that lists help messages that correspond to the help IDs of operational components, based on the management table 13b (operation S21). The file creation unit 14c creates a template file 13d based on the management table 13b (operation S22), and the process finishes.

The help creation support apparatus 10 identifies an operational component included in the graphical interface based on the source code 13a of the graphical interface. The help creation support apparatus 10 creates a management table 13b including a component ID that represents the operational component identified. The help creation support apparatus 10 stores the created management table 13b in the storage unit 13. The help creation support apparatus 10 receives from the input unit 11, for each of the pieces of identification information, a help message of the operational component to be added to the management table 13b that is stored in the storage unit 13. The help creation support apparatus 10 creates a help text file 13c in which help messages for the operational components are listed, based on the management table 13b that includes added help messages. Since a help message is created using the help text file 13c in which a help message for each operational component are listed, the frequency with which an operational component and a help message are mismatched may be reduced.

When the source code 13a is updated, the help creation support apparatus 10 compares the component IDs in the management table 13b created from the not-updated source code 13a with those in the management table 13b created from the updated source code 13a. Based on the result of the comparison, the help creation support apparatus 10 detects an added or deleted operational component. If there is an added or deleted operational component, the help creation support apparatus 10 notifies the developer of the added or deleted operational component. Thus, when an operational component is added to the source code 13a or deleted therefrom, the frequency with which, the developer forgets to update the help message of the added or deleted operational component may be reduced.

The help creation support apparatus 10 creates a template file 13d for the source code 13a in which a process of displaying help that correspond to operational components of the graphical interface is written. As a result, the time and effort for writing a process of calling a help may be reduced. Since the help creation support apparatus 10 writes a help reading process to the source code 13a using the template file 13d, the frequency with which a process of calling a help that corresponds to an operational component is omitted or the frequency with which an operational component and a help message are mismatched may be reduced.

The detection unit 14g compares the component IDs in the not-updated management table 13b with those in the updated management table 13b to detect an added or deleted operational component. For example, based on a comparison result between the not-updated source code 13a and the updated source code 13a, an added or deleted operational component or operational component whose operation has been changed may be detected, and then the result of the detection may be notified. Since the developer is notified of the added or deleted operational component or operational component whose operation has been changed, the frequency with which the developer forgets to update the help may be reduced.

The component IDs of the operational components included in the graphical interface may be managed by the management table 13b or may be managed in other forms.

The programming language may be Visual C++ or other programming languages such as Visual C# and Visual Basic.

The help creation support apparatus may be a computer help creation support apparatus with which a developer develops software, or may be a management server that manages the source code 13a that has been developed by a developer.

The components of each illustrated apparatus may be functional components or physical components. For example, all or some of the components may be distributed or combined functionally or physically in any format, depending on the load, operating state, or the like.EDITOR: changed For example, the processing units illustrated in FIG. 1, for example, the identification unit 14a, the creation unit 14b, the file creation unit 14c, the template creation unit 14d, the program creation unit 14e, the help creation unit 14f, and the detection unit 14g may be combined. Processes performed by multiple processing units may be separated. All or some of the functions of the processing units may be performed by a CPU, by a program which is analyzed and executed by a CPU, or may be performed by wired logic in hardware.

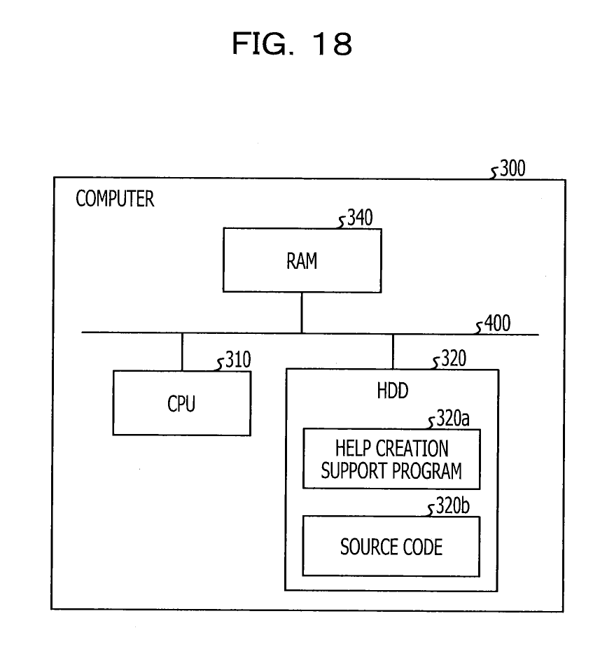

A previously prepared program may be executed by a computer system such as a personal computer or workstation. FIG. 18 illustrates an exemplary computer. The computer illustrated in FIG. 18 may execute a help creation support program.

As illustrated in FIG. 18, a computer 300 includes a central processing unit (CPU) 310, a hard disk drive (HDD) 320, and a random access memory (RAM) 340. The units 300 to 340 are connected together via a bus 400.

A help creation support program 320a having functions substantially identical or similar to those of the identification unit 14a, the creation unit 14b, the file creation unit 14c, the template creation unit 14d and the detection unit 14g illustrated in FIG. 1 is previously stored in the HDD 320. The help creation support program 320a may be divided as appropriate.

The HDD 320 stores various types of information. For example, the HDD 320 stores source code 320b that corresponds to the source code 13a illustrated in FIG. 1.

The CPU 310 reads the help creation support program 320a from the HDD 320 and loads the help creation support program 320a into the RAM 340 and executes the help creation support program 320a using the source code 320b stored in the HDD 320. Thus, processes substantially identical or similar to the processes performed by the control unit 14 illustrated in FIG. 1 are performed. The help creation support program 320a performs processes substantially identical or similar to the processes performed by the identification unit 14a, the creation unit 14b, the file creation unit 14c, the template creation unit 14d, and the detection unit 14g that are illustrated in FIG. 1.

The help creation support program 320a may be desired not to be initially stored in the HDD 320.

For example, the program may be stored in a transportable physical medium to be inserted into the computer 300, such as a floppy disk (FD), compact disc read-only memory (CD-ROM), digital versatile disk (DVD), magneto-optical disc, or IC card. The computer 300 may read the program from the transportable physical medium and execute the program.

The program may be stored in another computer (or server) or the like connected to the computer 300 via a public line, the Internet, a LAN, a WAN, or the like. The computer 300 may read the program from the other computer and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A help creation support apparatus comprising:
an identification unit to identify a operational component included in a graphical interface based on source code of the graphical interface;
a generation unit to generate management information including identification information that represents the identified operational component;
a storage unit to store the management information;
an input unit to input a help corresponding to the operational component to be added to the management information stored in the storage unit for identification information; and
a file creation unit to create a file in which the help corresponding to the operational component is stored based on management information to which the help is added.

2. The help creation support apparatus according to claim 1, further comprising:
a detection unit to compare first identification information in management information based on not-updated source code with second identification information in management information based on updated source code and to detect an added or deleted operational component based on a comparison result; and
a notification unit to notify the detected operational component.

3. The help creation support apparatus according to claim 2, wherein
the detection unit compares the not-updated source code and the updated source code and detects an operational component having a changed processing.

4. The help creation support apparatus according to claim 1, further comprising,
a template creation unit to create a source code template including a process of causing the operational component to displaying the help corresponding to the operational component.

5. A method for creating a help, comprising:
causing a computer to execute operation of:
identifying component operational component included in a graphical interface based on source code of the graphical interface;
generating management information including identification information that represent the identified operational component;
storing the management information in a storage unit;
adding a help which is input for the identification information to the management information; and
creating a file to store a help corresponding to the operational component based on management information having the added help.

6. The method according to claim 5, further comprising:
comparing first identification information in management information based on not-updated source code with second identification information in management information based on updated source code;
detecting an added or deleted operational component based on a comparison result; and
notifying the detected operational component.

7. The method according to claim 6, wherein an operational component whose operation has been changed is detected by comparing the not-updated source code and the updated source code.

8. The method for creating a help according to claim 5, further comprising,
creating a source code template including a process of causing the operational component to displaying the help corresponding to the operational component.

9. A storage medium storing a program cause a computer to:
identify component operational component included in a graphical interface based on source code of the graphical interface;
generate management information including identification information that represent the identified operational component;
store the management information in a storage unit;
add a help which is input for the identification information to the management information; and
create a file to store a help corresponding to the operational component based on management information having the added help.

10. The storage medium according to claim 9, wherein the program cause the computer to:
compare first identification information in management information based on not-updated source code with second identification information in management information based on updated source code;
detect an added or deleted operational component based on a comparison result; and
notify the detected operational component.

11. The storage medium according to claim 9, wherein the program cause the computer to,
create a source code template including a process of causing the operational component to displaying the help corresponding to the operational component.
